(19) United States
(12) Patent Application Publication
(10) Pub. No.: US 2016/0007625 A1
(43) Pub. Date: Jan. 14, 2016

(54) COFFEE DRINK

(71) Applicant: KAO CORPORATION, Chuo-ku, Tokyo (JP)

(72) Inventor: Sayaka DOMON, Sumida-ku (JP)

(73) Assignee: KAO CORPORATION, Chuo-ku, Tokyo (JP)

(21) Appl. No.: 14/772,294

(22) PCT Filed: Feb. 26, 2014
(86) PCT No.: PCT/JP2014/054638

§ 371 Date: Sep. 2, 2015

(30) Foreign Application Priority Data
Mar. 4, 2013 (JP) 2013-042438

(51) Int. Cl. A23F 5/18; A23F 5/24

(52) U.S. Cl. CPC A23F 5/185; A23F 5/243

(57) ABSTRACT

Provided is a coffee beverage, including the following components (A), (B), and (C): (A) at least one selected from the group consisting of catechol and pyrogallol; (B) 3,4-dicaffeoyl-1,5-quinolactone; and (C) chlorogenic acids, in which a ratio of a total peak area of the component (A) to a peak area of the component (B), ((A)/(B)), as determined by liquid chromatography-time of flight mass spectrometry (LC-TOF/MS) of the coffee beverage, is from 0 to 2.0, and in which a content of the component (C) in the coffee beverage is from 0.05 to 2% by mass.

### FIELD OF THE INVENTION

The present invention relates to a coffee beverage.

### BACKGROUND OF THE INVENTION

The taste and flavor of a coffee beverage include bitterness, sourness, sweetness, richness, and the like, which are sensed on the tongue as a sense of taste, and an odor that is sensed by the nose as a sense of smell. In addition, the odor of the coffee beverage includes orthonasal aroma, which is directly sensed by the nose as an odor of fresh coffee, and retronasal aroma, which spreads from the throat to the nose when the coffee beverage is drunk. The retronasal aroma is an important element that defines favorable taste of the coffee beverage.

The taste and flavor of the coffee beverage is characterized by a kind of green coffee beans to be used as a raw material or a roasting method therefor, and in roasting of green coffee beans, many components that are originally absent in the green coffee beans are generated. An example of such component is polyphenol such as 3,4-dicaffeoyl-1,5-quinolactone, catechol, or pyrogallol.

3,4-Dicaffeoyl-1,5-quinolactone is one of chlorogenic acid lactones, and is known as a bitterness component.

On the other hand, catechol and pyrogallol have been reported to be associated with gastric irritation, and it has been reported that a coffee product gentle on the stomach can be obtained by controlling the concentrations of catechol and pyrogallol in coffee beans (Patent Document 1). It has also been reported that, when a total content of monocyclic aromatic polyhydric alcohol such as hydroxyhydroquinone, pyrogallol, hydroquinone, and catechol in a coffee beverage is reduced to a specific range, the coffee beverage prevents stomachache and heartburn and is gentle on the stomach (Patent Document 2). However, there is no report on the taste and flavor of catechol and pyrogallol.

### CITATION LIST

### Patent Document

[Patent Document 1] JP-A-2009-515547

[Patent Document 2] JP-A-2009-28013

### SUMMARY OF THE INVENTION

The present invention is as described below.
(1) A coffee beverage, comprising the following components (A) and (B):

(A) at least one selected from the group consisting of catechol and pyrogallol; and

(B) 3,4-dicaffeoyl-1,5-quinolactone,

in which a ratio of a total peak area of the component (A) to a peak area of the component (B), ((A)/(B)), as determined by liquid chromatography-time of flight mass spectrometry (LC-TOF/MS) of the coffee beverage, is from 0 to 2.0.
(2) A method of reducing coarseness of a coffee beverage comprising the following components (A) and (B):

(A) at least one selected from the group consisting of catechol and pyrogallol; and

(B) 3,4-dicaffeoyl-1,5-quinolactone,

the method comprising adjusting a ratio of a total peak area of the component (A) to a peak area of the component (B), ((A)/(B)), as determined by liquid chromatography-time of flight mass spectrometry (LC-TOF/MS) of the coffee beverage, to from 0 to 2.0.
(3) A method of improving retronasal aroma of a coffee beverage comprising the following components (A) and (B):

(A) at least one selected from the group consisting of catechol and pyrogallol; and

(B) 3,4-dicaffeoyl-1,5-quinolactone,

the method comprising adjusting a ratio of a total peak area of the component (A) to a peak area of the component (B), ((A)/(B)), as determined by liquid chromatography-time of flight mass spectrometry (LC-TOF/MS) of the coffee beverage, to from 0 to 2.0.

### DETAILED DESCRIPTION OF THE INVENTION

The present invention relates to a coffee beverage having reduced coarseness and having good sharpness of bitterness and good retronasal aroma. The present invention also relates to a method of reducing coarseness of a coffee beverage and a method of improving retronasal aroma of a coffee beverage.

The present inventor made an investigation on bitterness to develop a coffee beverage having high preference. The coffee beverage is a beverage having favorable bitterness, and a typical example thereof is espresso. In recent years, people tend to like a coffee beverage that provides good sharp bitterness when drunk without lasting bitterness. When unfavorable bitterness remains as an aftertaste, the taste of the coffee beverage may deteriorate. The term “aftertaste” as used herein refers to “feeling that remains in the mouse” described in JIS Z 8144:2004. As a result of an investigation on the cause of deteriorated sharpness of bitterness, it found that coarseness is involved in the deterioration of sharpness of bitterness and that the deteriorated sharpness of bitterness causes deterioration of retronasal aroma. Further, as a result of a detailed investigation to reduce coarseness of a coffee beverage, it found that a specific polyphenol generated by roasting of coffee beans is involved in the coarseness. In addition, it found that when a content ratio of the polyphenol to that of a specific bitterness component is controlled, a coffee beverage having suppressed coarseness and having sharpness of bitterness and retronasal aroma improved by the suppressed coarseness is produced.

According to the present invention, it is possible to produce a coffee beverage having suppressed coarseness and having sharpness of bitterness and retronasal aroma improved by the suppressed coarseness. According to the present invention, it is also possible to provide a method of reducing coarseness of a coffee beverage and a method of improving retronasal aroma of a coffee beverage.

The coffee beverage of the present invention comprises, as a component (A), at least one selected from the group consisting of catechol and pyrogallol, which are substances responsible for coarseness, and as a component (B), 3,4-dicaffeoyl-1,5-quinolactone having quality bitterness. In the coffee beverage of the present invention, the amount of the component (A) is significantly reduced as compared to that in a normal coffee beverage, which increases the content ratio of the component (B) to the component (A). As a result, the coffee beverage of the present invention can provide good sharpness of bitterness and sufficiently high retronasal aroma when drunk.

In the coffee beverage of the present invention, a content of the component (A) is significantly reduced as compared to that in a normal coffee beverage, and the coffee beverage is not necessarily required to comprise the component (A). The content ratio can be determined by liquid chromatography-time of flight mass spectrometry (LC-TOF/MS) of the coffee beverage as a ratio of a total peak area of the component (A) to a peak area of the component (B), ((A)/(B)).

The peak area ratio ((A)/(B)) in the coffee beverage of the present invention is from 0 to 2.0, and is preferably 1.5 or less, more preferably 1.0 or less, even more preferably 0.6 or less, from the viewpoint of improving sharpness of bitterness and retronasal aroma by suppressing coarseness. It should be noted that the lower limit of the peak area ratio ((A)/(B)) is preferably 0.0001 or more, more preferably 0.001 or more, even more preferably 0.01 or more, from the viewpoint of production efficiency. The peak area ratio ((A)/(B)) ranges preferably from 0 to 1.5, more preferably from 0.0001 to 1.5, more preferably from 0.001 to 1.0, even more preferably from 0.01 to 0.6. It should be noted that the peak area ratio ((A)/(B)) is measured in conformity to a method described in Examples below.

A total content of the component (A) in the coffee beverage of the present invention is preferably 10 ppm by mass or less, more preferably 8 ppm by mass or less, even more preferably 7 ppm by mass or less, from the viewpoints of further reducing coarseness and improving sharpness of bitterness and retronasal aroma. In addition, a content of catechol as the component (A) in the coffee beverage of the present invention is preferably 8 ppm by mass or less, more preferably 7 ppm by mass or less, more preferably 6 ppm by mass or less, even more preferably 5 ppm by mass or less, from the viewpoints of further reducing coarseness and improving sharpness of bitterness and retronasal aroma. It should be noted that the lower limit of the total content of the component (A) in the coffee beverage of the present invention is not particularly limited and may be 0 ppm by mass. It is preferably 0.01 ppm by mass, more preferably 0.1 ppm by mass, even more preferably 1 ppm by mass, from the viewpoint of production efficiency. In addition, the lower limit of the content of catechol as the component (A) is not particularly limited and may be 0 ppm by mass in the coffee beverage of the present invention. It is preferably 0.01 ppm by mass, more preferably 0.1 ppm by mass, from the viewpoint of production efficiency. The total content of the component (A) in the coffee beverage of the present invention ranges preferably from 0 to 10 ppm by mass, more preferably from 0.01 to 10 ppm by mass, more preferably from 0.1 to 8 ppm by mass, even more preferably from 1 to 7 ppm by mass. In addition, the content of catechol as the component (A) in the coffee beverage of the present invention ranges preferably from 0 to 8 ppm by mass, more preferably from 0.01 to 7 ppm by mass, more preferably from 0.01 to 6 ppm by mass, even more preferably from 0.1 to 5 ppm by mass. It should be noted that the component (A) is analyzed in conformity to a method described in Examples below. In addition, a content of 0 ppm by mass in the analysis of the component (A) refers to a concept including below the detection limit.

The coffee beverage of the present invention may further comprise chlorogenic acids as a component (C). The term “chlorogenic acids” as used herein is a general term collectively encompassing: monocaffeoylquinic acids including 3-caffeoylquinic acid, 4-caffeoylquinic acid, and 5-caffeoylquinic acid; monoferuloylquinic acids including 3-feruloylquinic acid, 4-feruloylquinic acid, and 5-feruloylquinic acid; and dicaffeoylquinic acids including 3,4-dicaffeoylquinic acid, 3,5-dicaffeoylquinic acid, and 4,5-dicaffeoylquinic acid. In the present invention, at least one out of the nine kinds of chlorogenic acids has only to be incorporated.

A content of the component (C) in the coffee beverage of the present invention is preferably 0.01% by mass or more, more preferably 0.05% by mass or more, more preferably 0.07% by mass or more, more preferably 0.1% by mass or more, more preferably 0.12% by mass or more, even more preferably 0.15% by mass or more, from the viewpoint of physiological activity, and is preferably 2% by mass or less, more preferably 1% by mass or less, more preferably 0.8% by mass or less, more preferably 0.5% by mass or less, even more preferably 0.3% by mass or less, from the viewpoint of taste and flavor. The content of the component (C) in the coffee beverage of the present invention ranges preferably from 0.01 to 2% by mass, more preferably from 0.05 to 2% by mass, more preferably from 0.05 to 1% by mass, more preferably from 0.07 to 0.8% by mass, more preferably from 0.1 to 0.8% by mass, more preferably from 0.12 to 0.5% by mass, even more preferably from 0.15 to 0.3% by mass. It should be noted that the content of the component (C) is defined based on the total amount of the nine chlorogenic acids described above, and the component (C) is analyzed in conformity to a method described in Examples below.

The coffee beverage of the present invention may further comprise caffeine as a component (D). A content of the component (D) in the coffee beverage of the present invention is preferably 0.01% by mass or more, more preferably 0.015% by mass or more, more preferably 0.02% by mass or more, even more preferably 0.025% by mass or more, from the viewpoint of imparting bitterness, and is preferably 0.1% by mass or less, more preferably 0.08% by mass or less, more preferably 0.06% by mass or less, even more preferably 0.04% by mass or less, from the viewpoint of taste and flavor. The content of the component (D) in the coffee beverage of the present invention ranges preferably from 0.1 to 0.1% by mass, more preferably from 0.015 to 0.08% by mass, more preferably from 0.02 to 0.06% by mass, even more preferably from 0.025 to 0.04% by mass. It should be noted that the component (C) is analyzed in conformity to a method described in Examples below.

A Brix (20° C.) of the coffee beverage of the present invention is preferably 0.8 or more, more preferably 1.0 or more, more preferably 1.2 or more, even more preferably 1.5 or more, and is preferably 3.0 or less, more preferably 2.5 or less, even more preferably 2.3 or less, from the viewpoint of imparting rich body. The Brix of the coffee beverage of the present invention ranges preferably from 0.8 to 3.0, more preferably from 1.0 to 2.5, more preferably from 1.2 to 2.5, even more preferably from 1.5 to 2.3.

The coffee beverage of the present invention has preferably an acidic property from the viewpoint of taste and flavor. Specifically, the pH (20° C.) of the coffee beverage is preferably 4.0 or more, more preferably 4.3 or more, even more preferably 4.5 or more, and is preferably 6.0 or less, more preferably 5.9 or less, even more preferably 5.8 or less. The pH (20° C.) of the coffee beverage ranges preferably from 4.0 to 6.0, more preferably from 4.3 to 5.9, even more preferably from 4.5 to 5.8.

The coffee beverage may be, for example, prepared by using a coffee extract as such obtained by controlling the content of the component (A) and the peak area ratio ((A)/(B)) to the ranges described above, or prepared by the coffee extract diluted with water.

The coffee extract having the content of the component (A) and the peak area ratio ((A)/(B)) controlled to the ranges described above can be prepared by, for example, (i) subjecting a raw material roasted coffee bean extract to any chromatograph such as reversed phase chromatography or liquid chromatography to fractionate the component (A), and to reduce the content of the component (A) in the raw material roasted coffee bean extract, and if necessary, adding the component (B), thereby controlling the peak area ratio ((A)/(B)) to the range described above, or (ii) controlling the amounts of the components (A) and (B) to be extracted from roasted coffee beans and the amounts of the components (A) and (B) to be adsorbed on activated carbon by a method involving placing roasted coffee beans and activated carbon having average particle sizes controlled to specific ranges with the same container, feeding a solvent for extraction in the container to yield a coffee extract solution, and bringing the coffee extract solution into contact with the activated carbon in the container. In addition, in case of (ii), the component (B) may he added, if necessary. It should be noted that, as a fractionation method in the method (i), a known method may be employed appropriately. Hereinafter, the method (ii) is described.

The roasted coffee beans to be used in the present invention have an average particle size of preferably from 0.90 to 1.40 mm, more preferably from 0.96 to 1.33 mm. The term “average particle size” as used herein refers to a mass average particle size calculated by determining particle sizes in conformity to the section 6.3 of JIS K1474, determining the particle size distribution in conformity to the section 6.4, and calculating a mass average particle size in conformity to the section 6.4-b)-7).

An L value of the roasted coffee beans, measured with a colorimeter, is preferably from 10 to 60, more preferably from 15 to 35, and a mixture of coffee beans having different roasting degrees may be used. It should be noted that a roasting method and roasting conditions are not particularly limited. Examples of the kind of the coffee beans include Coffea Arabica, Coffea Robusta and Coffea Liberica, and a mixture of one or two or more of coffee beans may be used.

In addition, the activated carbon to be used in the present invention has an average particle size of preferably from 0.30 to 0.60 mm, more preferably from 0.32 to 0.45 mm. The term “average particle size” as used in this case also refers to a mass average particle size calculated in conformity to JIS K1474. It should be noted that examples of a raw material from which the activated carbon is derived include a wood material (for example, sawdust), coal, and palm shell or the like, and of those, palm shell activated carbon is preferred. In addition, activated carbon having been activated by a gas such as water vapor or a chemical may be used, and of those, activated carbon activated by water vapor is preferred. A usage of the activated carbon is preferably from 10 to 35% by mass, more preferably from 20 to 28% by mass, with respect to the roasted coffee beans.

The roasted coffee beans and activated carbon having average particle sizes controlled may be obtained by, if necessary, pulverizing roasted coffee beans and activated carbon and sieving the pulverized products to collect ones having desired average particle sizes. The pulverization method is not particularly limited, and a known method and apparatus may be used. It should be noted that classification of the roasted coffee beans and activated carbon may be performed by using, for example, a sieve manufactured by Tyler (JIS Z 8801-1).

Next, the roasted coffee beans and activated carbon are placed in a container. Examples of the container include a drip extractor and a column extractor.

In addition, after addition of the activated carbon to the container, the activated carbon may be washed by passing water through the container before placing the roasted coffee beans. It should be noted that the water used for washing is discharged outside the container. A temperature of the water is preferably from 60 to 100° C., more preferably from 70 to 95° C. An amount of the water to be used for washing is, with respect to that of the activated carbon, preferably from 5 to 200 times by mass, more preferably from 15 to 50 times by mass.

Next, a solvent for extraction is fed to the container containing the roasted coffee beans and activated carbon placed therein.

From the viewpoint of taste and flavor, the solvent for extraction is preferably water, and tap water, natural water, distilled water, ion-exchange water, or the like may be appropriately selected and used. A temperature of the solvent for extraction is preferably from 70 to 90° C., more preferably from 77 to 87° C.

In addition, after feeding a contact amount of the solvent for extraction to the roasted coffee beans, the feed of the solvent for extraction may be stopped, and the state may be maintained for a predetermined period of time. In this case, the amount of the solvent for extraction to be fed is preferably from 0.5 to 10 times by mass with respect to that of the roasted coffee beans, and the period of time for which the state is maintained is preferably from 1 to 20 minutes, more preferably from 5 to 16 minutes, from the viewpoint of taste and flavor.

Next, the coffee extract is discharged outside the container, and the discharge is preferably stopped when an extraction ratio of the coffee extract solution, that is, a ratio of the mass of the coffee extract solution to the mass of the roasted coffee beans reaches a predetermined ratio. The extraction ratio of the coffee extract solution is preferably from 1 times by mass to 15 times by mass, more preferably from 4 times by mass to 12 times by mass, with respect to the roasted coffee beans.

The discharged coffee extract solution is cooled, and after that, may be treated by filtration, centrifugation, or the like, if necessary.

Thus, a coffee extract having the content of the component (A) and the peak area ratio ((A)/(B)) controlled to the ranges described above can be obtained, and if necessary, the component (B) may be added to adjust the mass ratio ((A)/(B)).

In addition, as required, the coffee beverage of the present invention may contain one or two or more of additives such as a sweetener, a milk component, an antioxidant, a flavor, an organic acid, an organic acid salt, an inorganic acid, an inorganic acid salt, an inorganic salt, a dye, an emulsifier, a preservative, a seasoning, an acidulant, an amino acid, a pH regulator, and a quality stabilizer. The coffee beverage of the present invention may be a black coffee beverage or a milk coffee beverage.

The coffee beverage of the present invention may be provided as a packaged coffee beverage by filling a conventional package, such as a molded container formed of polyethylene terephthalate as a main component (a so-called PET bottle), a metal can, a paper package in combination with metal foil or a plastic film, and a bottle, with the beverage.

In addition, the coffee beverage can be produced, for example, by putting the beverage in a container such as a metal can and, when sterilized with heating is feasible, conducting heat sterilization under the sterilization conditions defined by the corresponding law (the Food Sanitation Act in Japan). In the case of a container such as a PET bottle or a paper container to which retort sterilization cannot be applied, the coffee beverage is previously sterilized for example, at a high temperature for a short time sterilization under the equivalent conditions as aforementioned above, by a plate-type heat exchanger or the like, is cooled to a predetermined temperature, and then is filling in a container.

Hereinafter, the method of reducing coarseness of a coffee beverage and the method of improving retronasal aroma of a coffee beverage are described.

The method of reducing coarseness of a coffee beverage and method of improving retronasal aroma of a coffee beverage of the present invention each involve adjusting a ratio of the total peak area of the component (A) to the peak area of the component (B), ((A)/(B)), determined by analyzing the coffee beverage through liquid chromatography-time of flight mass spectrometry (LC-TOF/MS), to from 0 to 2.0. The preferred embodiment of the ratio of the peak area of the component (A) to the peak area of the component (B), ((A)/(B)), is as described above.

In addition, the method of reducing coarseness of a coffee beverage and method of improving retronasal aroma of a coffee beverage of the present invention may each involve: adjusting the content of the component (A) in the coffee beverage from the viewpoints of further reducing coarseness and improving sharpness of bitterness and retronasal aroma; adjusting the content of the chlorogenic acids as the component (C) in the coffee beverage from the viewpoints of physiological activity and taste and flavor; adjusting the content of caffeine as the component (D) from the viewpoints of imparting bitterness and of taste and flavor; adjusting the pH from the viewpoint of taste and flavor; and adjusting the Brix from the viewpoint of imparting richness. The preferred embodiments of the content of the component (A), the content of the chlorogenic acids as the component (C), the content of caffeine as the component (D), pH, and Brix in the coffee beverage are as described above.

That is, the present invention further discloses the following coffee beverage, as well as method of reducing coarseness of a coffee beverage and method of improving retronasal aroma of a coffee beverage regarding the embodiments described above.

<1-1>

A coffee beverage, comprising the following components (A) and (B):

(A) at least one selected from the group consisting of catechol and pyrogallol; and

(B) 3,4-dicaffeoyl-1,5-quinolactone,

in which a ratio of a total peak area of the component (A) to a peak area of the component (B), ((A)/(B)), as determined by liquid chromatography-time of flight mass spectrometry (LC-TOF/MS) of the coffee beverage, is from 0 to 2.0.

<1-2>

The coffee beverage according to the above-mentioned item <1-1>, in which the ratio of the total peak area of the component (A) to the peak area of the component (B), ((A)/(B)), as determined by LC-TOF/MS, is preferably 1.5 or less, more preferably 1.0 or less, even more preferably 0.6 or less, and is preferably 0.0001 or more, more preferably 0.001 or more, even more preferably 0.01 or more.

<1-3>

The coffee beverage according to the above-mentioned item <1-1> or <1-2>, in which the ratio of the total peak area of the component (A) to the peak area of the component (B), ((A)/(B)), as determined by LC-TOF/MS, is preferably from 0 to 1.5, more preferably from 0.0001 to 1.5, more preferably from 0.001 to 1.0, even more preferably from 0.01 to 0.6.

<1-4>

The coffee beverage according to anyone of the above-mentioned items <1-1> to <1-3>, in which a total content of the component (A) in the coffee beverage is preferably 10 ppm by mass or less, more preferably 8 ppm by mass or less, even more preferably 7 ppm by mass or less, and is preferably 0 ppm by mass or more, more preferably 0.01 ppm by mass or more, more preferably 0.1 ppm by mass or more, even more preferably 1 ppm by mass or more.

<1-5>

The coffee beverage according to anyone of the above-mentioned items <1-1> to <1-4>, in which the total content of the component (A) in the coffee beverage is preferably from 0 to 10 ppm by mass, more preferably from 0.01 to 10 ppm by mass, more preferably from 0.1 to 8 ppm by mass, even more preferably from 1 to 7 ppm by mass.

<1-6>

The coffee beverage according to anyone of the above-mentioned items <1-1> to <1-5>, in which a content of catechol as the component (A) in the coffee beverage is preferably 8 ppm by mass or less, more preferably 7 ppm by mass or less, more preferably 6 ppm by mass or less, even more preferably 5 ppm by mass or less, and is preferably 0 ppm by mass or more, more preferably 0.01 ppm by mass or more, even more preferably 0.1 ppm by mass or more.

<1-7>

The coffee beverage according to anyone of the above-mentioned items <1-1> to <1-6>, in which the content of catechol as the component (A) in the coffee beverage is preferably from 0 to 8 ppm by mass, more preferably from 0.01 to 7 ppm by mass, more preferably from 0.01 to 6 ppm by mass, even more preferably from 0.1 to 5 ppm by mass.

<1-8>

The coffee beverage according to anyone of the above-mentioned items <1-1> to <1-7>, preferably further comprising chlorogenic acids as a component (C).

<1-9>

The coffee beverage according to the above-mentioned item <1-8>, in which the chlorogenic acids preferably comprise at least one selected from the group consisting of 3-caffeoylquinic acid, 4-caffeoylquinic acid, 5-caffeoylquinic acid, 3-feruloylquinic acid, 4-feruloylquinic acid, 5-feruloylquinic acid, 3,4-dicaffeoylquinic acid, 3,5-dicaffeoylquinic acid, and 4,5-dicaffeoylquinic acid.

<1-10>

The coffee beverage according to the above-mentioned item <1-8> or <1-9>, in which a content of the component (C) in the coffee beverage is preferably 0.01% by mass or more, more preferably 0.05% by mass or more, more preferably 0.07% by mass or more, more preferably 0.1% by mass or more, more preferably 0.12% by mass or more, even more preferably 0.15% by mass or more, and is preferably 2% by mass or less, more preferably 1% by mass or less, more preferably 0.8% by mass or less, even more preferably 0.5% by mass or less.

<1-11>

The coffee beverage according to any one of the above-mentioned items <1-8> to <1-10>, in which the content of the component (C) in the coffee beverage is preferably from 0.01 to 2% by mass, more preferably from 0.05 to 2% by mass, more preferably from 0.05 to 1% by mass, more preferably from 0.07 to 0.8% by mass, more preferably from 0.1 to 0.8% by mass, more preferably from 0.12 to 0.5% by mass, even more preferably from 0.15 to 0.3% by mass.

<1-12>

The coffee beverage according to anyone of the above-mentioned items <1-1> to <1-11>, preferably further comprising caffeine as a component (D), in which a content of the component (D) in the coffee beverage is preferably 0.01% by mass or more, more preferably 0.015% by mass, more preferably 0.02% by mass or more, even more preferably 0.025% by mass or more, and is preferably 0.1% by mass or less, more preferably 0.08% by mass or less, more preferably 0.06% by mass or less, even more preferably 0.04% by mass or less.

<1-13>

The coffee beverage according to anyone of the above-mentioned items <1-1> to <1-12>, preferably further comprising caffeine as a component (D), in which the content of the component (D) in the coffee beverage is preferably from 0.01 to 0.1% by mass, more preferably from 0.015 to 0.08% by mass, more preferably from 0.02 to 0.06% by mass, even more preferably from 0.025 to 0.04% by mass.

<1-14>

The coffee beverage according to any one of the above-mentioned items <1-1> to <1-13>, in which the coffee beverage has a pH (20° C.) of preferably 4.0 or more, more preferably 4.3 or more, even more preferably 4.5 or more, and of preferably 6.0 or less, more preferably 5.9 or less, even more preferably 5.8 or less.

<1-15>

The coffee beverage according to anyone of the above-mentioned items <1-1> to <1-14>, in which the coffee beverage has the pH (20° C.) of preferably from 4.0 to 6.0, more preferably from 4.3 to 5.9, even more preferably from 4.5 to 5.8.

<1-16>

The coffee beverage according to anyone of the above-mentioned items <1-1> to <1-15>, in which the coffee beverage has a Brix (20° C.) of preferably 0.8 or more, more preferably 1.0 or more, more preferably 1.2 or more, even more preferably 1.5 or more, and of preferably 3.0 or less, more preferably 2.5 or less, even more preferably 2.3 or less.

<1-17>

The coffee beverage according to anyone of the above-mentioned items <1-1> to <1-16>, in which the coffee beverage has the Brix (20° C.) of preferably from 0.8 to 3.0, more preferably from 1.0 to 2.5, more preferably from 1.2 to 2.5, even more preferably from 1.5 to 2.3.

<1-18>

The coffee beverage according to any one of the above-mentioned items <1-1> to <1-17>, which is preferably a packaged coffee beverage.

<1-19>

The coffee beverage according to anyone of the above-mentioned items <1-1> to <1-18>, which is preferably a black coffee beverage.

<1-20>

The coffee beverage according to any one of the above-mentioned items <1-1> to <1-19>, which is preferably a milk coffee beverage.

<1-21>

The coffee beverage according to anyone of the above-mentioned items <1-1> to <1-20>, preferably further comprising one or two or more of additives selected from the group consisting of a sweetener, a milk component, an antioxidant, a flavor, an organic acid, an organic acid salt, an inorganic acid, an inorganic acid salt, an inorganic salt, a dye, an emulsifier, a preservative, a seasoning, an acidulant, an amino acid, a pH regulator, and a quality stabilizer.

<1-22>

The coffee beverage according to anyone of the above-mentioned items <1-1> to <1-21>, which is preferably subjected to a heat sterilization.

<2-1>

A method of reducing coarseness of a coffee beverage comprising the following components (A) and (B):

(A) at least one selected from the group consisting of catechol and pyrogallol; and

(B) 3,4-dicaffeoyl-1,5-quinolactone,

the method comprising adjusting a ratio of a total peak area of the component (A) to a peak area of the component (B), ((A)/(B)), as determined by liquid chromatography-time of flight mass spectrometry (LC-TOF/MS) of the coffee beverage, to from 0 to 2.0.

<2-2>

A method of improving retronasal aroma of a coffee beverage comprising the following components (A) and (B):

(A) at least one selected from the group consisting of catechol and pyrogallol; and

(B) 3,4-dicaffeoyl-1,5-quinolactone,

the method comprising adjusting a ratio of a total peak area of the component (A) to a peak area of the component (B), ((A)/(B)), as determined by liquid chromatography-time of flight mass spectrometry (LC-TOF/MS) of the coffee beverage, to from 0 to 2.0.

<2-3>

The method according to the above-mentioned item <2-1> or <2-2>, in which the ratio of the total peak area of the component (A) to the peak area of the component (B), ((A)/(B)), as determined by LC-TOF/MS, is adjusted to preferably 1.5 or less, more preferably 1.0 or less, even more preferably 0.6 or less, and is adjusted to preferably 0.0001 or more, more preferably 0.001 or more, even more preferably 0.01 or more.

<2-4>

The method according to any one of the above-mentioned items <2-1> to <2-3>, in which the ratio of the total peak area of the component (A) to the peak area of the component (B), ((A)/(B)), as determined by LC-TOF/MS, is adjusted to preferably from 0 to 1.5, more preferably from 0.0001 to 1.5, more preferably from 0.001 to 1.0, even more preferably from 0.01 to 0.6.

<2-5>

The method according to any one of the above-mentioned items <2-1> to <2-4>, further comprising adjusting a total content of the component (A) in the coffee beverage to preferably 10 ppm by mass or less, more preferably 8 ppm by mass or less, even more preferably 7 ppm by mass or less, and preferably 0 ppm by mass or more, more preferably 0.01 ppm by mass or more, more preferably 0.1 ppm by mass or more, even more preferably 1 ppm by mass or more.

<2-6>

The method according to any one of the above-mentioned items <2-1> to <2-5>, further comprising adjusting the total content of the component (A) in the coffee beverage to preferably from 0 to 10 ppm by mass, more preferably from 0.01 to 10 ppm by mass, more preferably from 0.1 to 8 ppm by mass, even more preferably from 1 to 7 ppm by mass.

<2-7>

The method according to any one of the above-mentioned items <2-1> to <2-6>, further comprising adjusting a content of catechol as the component (A) in the coffee beverage to preferably 8 ppm by mass, more preferably 7 ppm by mass or less, more preferably 6 ppm by mass or less, even more preferably 5 ppm by mass or less, and preferably 0 ppm by mass or more, more preferably 0.01 ppm by mass or more, even more preferably 0.1 ppm by mass or more.

<2-8>

The method according to any one of the above-mentioned items <2-1> to <2-7>, further comprising adjusting the content of catechol as the component (A) in the coffee beverage to preferably from 0 to 8 ppm by mass, more preferably from 0.01 to 7 ppm by mass, more preferably from 0.01 to 6 ppm by mass, even more preferably from 0.1 to 5 ppm by mass.

<2-9>

The method according to any one of the above-mentioned items <2-1> to <2-8>, further comprising adjusting a content of chlorogenic acids as a component (C) in the coffee beverage to preferably 0.01% by mass or more, more preferably 0.05% by mass or more, more preferably 0.07% by mass or more, more preferably 0.1% by mass or more, more preferably 0.12% by mass or more, even more preferably 0.15% by mass or more, and preferably 2% by mass or less, more preferably 1% by mass or less, more preferably 0.8% by mass or less, even more preferably 0.5% by mass or less.

<2-10>

The method according to any one of the above-mentioned items <2-1> to <2-9>, further comprising adjusting the content of the chlorogenic acids as a component (C) in the coffee beverage to preferably from 0.01 to 2% by mass, more preferably from 0.05 to 2% by mass, more preferably from 0.05 to 1% by mass, more preferably from 0.07 to 0.8% by mass, more preferably from 0.1 to 0.8% by mass, more preferably from 0.12 to 0.5% by mass, even more preferably from 0.15 to 0.3% by mass.

<2-11>

The method according to the above-mentioned item <2-9> or <2-10>, in which the chlorogenic acids preferably comprise at least one selected from the group consisting of 3-caffeoylquinic acid, 4-caffeoylquinic acid, 5-caffeoylquinic acid, 3-feruloylquinic acid, 4-feruloylquinic acid, 5-feruloylquinic acid, 3,4-dicaffeoylquinic acid, 3,5-dicaffeoylquinic acid, and 4,5-dicaffeoylquinic acid.

<2-12>

The method according to any one of the above-mentioned items <2-1> to <2-11>, further comprising adjusting a content of caffeine as a component (D) in the coffee beverage to preferably 0.01% by mass or more, more preferably 0.015% by mass, more preferably 0.02% by mass or more, even more preferably 0.025% by mass or more, and preferably 0.1% by mass or less, more preferably 0.08% by mass or less, more preferably 0.06% by mass or less, even more preferably 0.04% by mass or less.

<2-13>

The method according to any one of the above-mentioned items <2-1> to <2-12>, further comprising adjusting the content of caffeine as a component (D) in the coffee beverage to preferably from 0.01 to 0.1% by mass, more preferably from 0.015 to 0.08% by mass, more preferably from 0.02 to 0.06% by mass, even more preferably from 0.025 to 0.04% by mass.

<2-14>

The method according to any one of the above-mentioned items <2-1> to <2-13>, further comprising adjusting a pH (20° C.) of the coffee beverage to preferably 4.0 or more, more preferably 4.3 or more, even more preferably 4.5 or more, and preferably 6.0 or less, more preferably 5.9 or less, even more preferably 5.8 or less.

<2-15>

The method according to any one of the above-mentioned items <2-1> to <2-14>, further comprising adjusting the pH (20° C.) of the coffee beverage to preferably from 4.0 to 6.0, more preferably from 4.3 to 5.9, even more preferably from 4.5 to 5.8.

<2-16>

The method according to any one of the above-mentioned items <2-1> to <2-15>, further comprising adjusting a Brix (20° C.) of the coffee beverage to preferably 0.8 or more, more preferably 1.0 or more, more preferably 1.2 or more, even more preferably 1.5 or more, and preferably 3.0 or less, more preferably 2.5 or less, even more preferably 2.3 or less.

<2-17>

The method according to any one of the above-mentioned items <2-1> to <2-16>, further comprising adjusting the Brix (20° C.) of the coffee beverage to preferably from 0.8 to 3.0, more preferably from 1.0 to 2.5, more preferably from 1.2 to 2.5, even more preferably from 1.5 to 2.3.

<2-18>

The method according to any one of the above-mentioned items <2-1> to <2-17>, in which the coffee beverage is preferably a packaged coffee beverage.

<2-19>

The method according to any one of the above-mentioned items <2-1> to <2-18>, in which the coffee beverage is preferably a black coffee beverage.

<2-20>

The method according to any one of the above-mentioned items <2-1> to <2-19>, in which the coffee beverage is preferably a milk coffee beverage.

<2-21>

The method according to any one of the above-mentioned items <2-1> to <2-20>, in which the coffee beverage is preferably a heat-sterilized coffee beverage.

### EXAMPLES

(1) Liquid Chromatography-Time of Flight Mass Spectrometry (LC-TOF/MS) of 3,4-Dicaffeoyl-1,5-quinolactone, Pyrogallol, and Catechol

LC-TOF/MS analysis was performed by using UPLC as an analyzer. The apparatus had constituent units as described below.
Analytical apparatus: ACQUITY UPLC (Waters) and LCT Premier XE (Waters)
Column: ACQUITY UPLC T3 2.1×50 mm (Waters)

Analysis conditions are as follows:
Sample injection volume: 5 μL,
Flow rate: 0.4 mL/min,
Predetermined temperature of column oven: 40° C.,
Eluent A: 0.1 (V/V) % formic acid aqueous solution,
Eluent B: 0.1 (V/V) % formic acid/acetonitrile solution.

Concentration Gradient Conditions

| Time | Eluent A | Eluent B |
|---|---|---|
| 0.00 min | 98% | 2% |
| 1.50 min | 98% | 2% |
| 8.25 min | 0% | 100% (linear gradient) |
| 9.25 min | 0% | 100% |
| 9.50 min | 98% | 2% |
| 10.00 min | 98% | 2% |

A sample was diluted to 1/20 with ultrapure water, subjected to ultrafiltration (cutoff molecular weight: 10,000), and then subjected to the analysis.

Retention Times of (A) Catechol and Pyrogallol
Catechol: 2.681 min
Pyrogallol: 1.188 min

Retention Time of (B) 3,4-Dicaffeoyl-1,5-quinolactone
5 peaks in total at 3.231 min, 3.725 min, 3.413 min, 3.648 min, and 3.796 min
Ionization mode: ESI Positive, Negative

Capillary voltage (Positive): 2,200 V

Capillary voltage (Negative): 2,200 V

Cone voltage (Positive): 50 V

Cone voltage (Negative): 50 V

Desolvation gas flow: 650 L/hr

Cone gas flow: 50 L/hr

Desolvation temperature: 450° C.

Source temperature: 120° C.
Measured m/z range: 50-1,000
Standard substance: Leucine, enkephalin: 0.1 ng/μL

(2) Quantification of Chlorogenic Acids and Caffeine

HPLC was used as an analyzer. The model numbers of constituent units in the analyzer are as follows:
UV-VIS detector: L-2420 (Hitachi High-Technologies Corporation),
Column oven: L-2300 (Hitachi High-Technologies Corporation),
Pump: L-2130 (Hitachi High-Technologies Corporation),
Autosampler: L-2200 (Hitachi High-Technologies Corporation),
Column: Cadenza CD-C18, 4.6 mm (inner diameter)×150 mm (length), particle diameter: 3 μm (Imtakt Corp.).
Detector

Analysis conditions are as follows:
Sample injection volume: 10 μL,
Flow rate: 1.0 mL/min,
Predetermined wavelength of UV-VIS detector: 325 nm,
Predetermined temperature of column oven: 35° C.,
Eluent A: 5 (V/V) % acetonitrile solution containing 0.05 M acetic acid, 0.1 mM 1-hydroxyethane-1,1-diphosphonic acid, and 10 mM sodium acetate,
Eluent B: acetonitrile.

Concentration Gradient Conditions

| Time | Eluent A | Eluent B |
|---|---|---|
| 0.0 min | 100% | 0% |
| 10.0 min | 100% | 0% |
| 15.0 min | 95% | 5% |
| 20.0 min | 95% | 5% |
| 22.0 min | 92% | 8% |
| 50.0 min | 92% | 8% |
| 52.0 min | 10% | 90% |
| 60.0 min | 10% | 90% |
| 60.1 min | 100% | 0% |
| 70.0 min | 100% | 0% |

In HPLC, 1 g of a sample was weighed accurately and diluted to 10 mL with Eluent A in a measuring cylinder, and the resultant was filtered by a membrane filter (GL chromatodisc 25A, pore diameter: 0.45 μm, GL Sciences Inc.), and was then analyzed.

Retention Time of (C) Chlorogenic Acids

### Nine Chlorogenic Acids

Monocaffeoylquinic acid: 3 peaks in total at 5.3 min, 8.8 min, and 11.6 min,
Monoferuloylquinic acid: 3 peaks in total at 13.0 min, 19.9 min, and 21.0 min,
Dicaffeoylquinic acid: 3 peaks in total at 36.6 min, 37.4 min, and 44.2 min.

From area values for the nine chlorogenic acids determined in the foregoing, the content of the chlorogenic acids was determined in terms of by mass by using 5-caffeoylquinic acid as a standard substance.

It should be noted that caffeine was analyzed in the same manner as that for the chlorogenic acids, except that the wavelength of the UV-VIS detector was set to 270 nm, and caffeine was used as a standard substance. The retention time of caffeine was 18.9 minutes.

(3) Quantitative Analysis of Catechol and Pyrogallol

CoulArray system (Model 5600A, manufactured by ESA, Inc., USA), which is a HPLC-electrochemical detector (coulometric type), was used as an analyzer. The names and model numbers of constituent units of the analyzer are as follows:
Analytical cell: Model 5010, CoulArray Organizer,
CoulArray Electronics Module and Software: Model 5600A,
Solvent delivery module: Model 582, Gradient Mixer,
Autosampler: Model 542, Pulse Damper,
Degasser: Degasys Ultimate DU3003,
Column oven: 505.
Column: CAPCELL PAK C18 AQ, 4.6 mm (inner diameter)×250 mm (length) Particle diameter: 5 μm (Shiseido Co., Ltd.)

Analysis conditions are as follows:
Sample injection volume: 10 μL,
Flow rate: 1.0 mL/min,
Voltage application of electrochemical detector: 0 mV,
Predetermined temperature of column oven: 40° C.,
Eluent C: 5 (V/V) % methanol solution containing 0.1 (W/V) % phosphoric acid and 0.1 mM 1-hydroxyethane-1,1-diphosphonic acid,
Eluent D: 50 (V/V) % methanol solution containing 0.1 (W/V) % phosphoric acid and 0.1 mM 1-hydroxyethane-1,1-diphosphonic acid.

For preparing Eluents C and D, distilled water for high-performance liquid chromatography (Kanto Chemical Co., Inc.), methanol for high-performance liquid chromatography (Kanto Chemical Co., Inc.), phosphoric acid (guaranteed reagent, Wako Pure Chemical Industries, Ltd.), and 1-hydroxyethane-1,1-diphosphonic acid (60% aqueous solution, Tokyo Kasei Kogyo Co., Ltd.) were used.

Concentration Gradient Conditions

| Time | Eluent C | Eluent D |
|---|---|---|
| 0.0 min | 100% | 0% |
| 10.0 min | 100% | 0% |
| 10.1 min | 0% | 100% |
| 20.0 min | 0% | 100% |
| 20.1 min | 100% | 0% |
| 50.0 min | 100% | 0% |

5 g of a sample was weighed accurately and diluted to 10 mL in a measuring cylinder with a 5 (V/V) % methanol solution containing 0.5 (W/V) % phosphoric acid and 0.5 mM 1-hydroxyethane-1,1-diphosphonic acid, and the resulting solution was centrifuged to separate the supernatant as a sample to be analyzed. The supernatant was allowed to pass through Bond Elut SCX (packed weight of solid phase: 500 mg, reservoir capacity: 3 mL, GL Sciences Inc.). A passed solution excluding about 0.5 mL of the initial passed solution was obtained. Immediately upon filtrating the passed solution by a membrane filter (GL chromatodisk 25A, pore size: 0.45 μm, GL Sciences Inc.), the filtrate was subjected to analysis.

In the analysis performed under the above-mentioned conditions, the retention time of pyrogallol was 7.87 minutes, whereas the retention time of catechol was 16.47 minutes. From the peak area values obtained, the total content of pyrogallol and catechol was determined in terms of % by mass with reference to hydroxyhydroquinone (Wako Pure Chemical Industries, Ltd.) as a standard substance.

(4) Measurement of Brix

The sugar refractometer index (Brix) at 20° C. of the sample was measured with a saccharimeter (Atago RX-5000 (manufactured by Atago Co., Ltd.)).

(5) Sensory Evaluation

Five expert panelists drunk each coffee beverage and evaluated its coarseness, sharpness of bitterness, and retronasal aroma in accordance with the following criteria. After that, discussion was made to determine the final score.

Evaluation Criteria of Coarseness

5: No coarseness is felt

4: Coarseness is hardly felt

3: Coarseness is slightly felt

2: Coarseness is felt

1: Coarseness is strongly felt

Evaluation Criteria of Sharpness of Bitterness

5: Having very good sharpness of bitterness

4: Having good sharpness of bitterness

3: Having slight sharpness of bitterness

2: Having slightly bad sharpness of bitterness

1: Having bad sharpness of bitterness

Evaluation Criteria of Retronasal Aroma

5: Having very good retronasal aroma

4: Having good retronasal aroma

3: Having slight retronasal aroma

2: Having slightly bad retronasal aroma

1: Having bad retronasal aroma

### Example 1

90 g of palm shell activated carbon activated with water vapor (average particle size: 0.370 mm) was placed in a drip extractor (inner diameter: 73 mm, volume: 11 L). Subsequently, hot water at 80° C. was fed for 10 minutes through a shower from above the activated carbon to sterilize the activated carbon. An amount of the hot water fed was 25 times by mass with respect to that of the activated carbon. After that, 400 g of roasted coffee beans having an L value of 26 (average particle size: 0.965 mm) was placed on the activated carbon. Subsequently, 0.25 kg of hot water at 80° C. was fed from the lower part of the drip extractor to fill the bottom of the extractor with the hot water. Next, hot water at 80° C. was fed through a shower from above the roasted coffee beans at a rate of 1.25 g/sec, and the feed of the hot water was stopped. The state was maintained for 10 minutes.

An amount of the hot water fed was 2.55 times by mass with respect to that of the roasted coffee beans. The discharge of a coffee extract solution was stopped when the amount of the collected solution reached 2.4 kg, and the resultant collected solution was obtained as a coffee extract.

Next, the coffee extract was diluted with water to prepare a coffee beverage. The resultant coffee beverage had a content of catechol of 2.69 ppm by mass and a content of pyrogallol of 0.54 ppm by mass. The resultant coffee beverage was analyzed and subjected to the sensory evaluation. The results are shown in Table 1.

### Example 2

1.0 ppm by mass of catechol was added to the coffee beverage obtained in Example 1 to prepare a coffee beverage. The resultant coffee beverage was analyzed and subjected to the sensory evaluation. The results are shown in Table 1.

### Example 3

1.0 ppm by mass of pyrogallol was added to the coffee beverage obtained in Example 1 to prepare a coffee beverage. The resultant coffee beverage was analyzed and subjected to the sensory evaluation. The results are shown in Table 1.

### Example 4

5.0 ppm by mass of catechol was added to the coffee beverage obtained in Example 1 to prepare a coffee beverage. The resultant coffee beverage was analyzed and subjected to the sensory evaluation. The results are shown in Table 1.

### Example 5

5.0 ppm by mass of pyrogallol was added to the coffee beverage obtained in Example 1 to prepare a coffee beverage. The resultant coffee beverage was analyzed and subjected to the sensory evaluation. The results are shown in Table 1.

### Example 6

The coffee beverage obtained in Example 1 was diluted twice with distilled water. The resultant coffee beverage was analyzed and subjected to the sensory evaluation. The results are shown in Table 1.

### Comparative Example 1

10 ppm by mass of catechol was added to the coffee beverage obtained in Example 1 to prepare a coffee beverage. The resultant coffee beverage was analyzed and subjected to the sensory evaluation. The results are shown in Table 1.

### Comparative Example 2

10 ppm by mass of pyrogallol was added to the coffee beverage obtained in Example 1 to prepare a coffee beverage. The resultant coffee beverage was analyzed and subjected to the sensory evaluation. The results are shown in Table 1.

### Comparative Example 3

A coffee beverage was prepared in the same manner as in Example 1 except that the treatment with the activated carbon was not performed in Example 1. The resultant coffee beverage was analyzed and subjected to the sensory evaluation. The results are shown in Table 1.

### Comparative Example 4

A commercially available canned black coffee beverage containing no sugar was analyzed and subjected to the sensory evaluation. The results are shown in Table 1.

TABLE 1

| | | | | | | | | Compar- | Compar- | Compar- | Compar- |
|---|---|---|---|---|---|---|---|---|---|---|---|
| | | | | | | | | ative | ative | ative | ative |
| | | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 1 | ple 2 | ple 3 | ple 4 |
| Analysis | Total of component | 0.58 | 0.75 | 0.84 | 1.41 | 1.87 | 0.58 | 2.24 | 3.16 | 2.69 | 67.67 |
| | (A)/(B) | | | | | | | | | | |
| | 3,4-dicaffeoyl-1,5- | | | | | | | | | | |
| | quinolactone (peak | | | | | | | | | | |
| | area ratio) | | | | | | | | | | |
| | (C) Chlorogenic acids | 0.2 | 0.2 | 0.2 | 0.2 | 0.2 | 0.1 | 0.2 | 0.2 | 0.19 | 0.039 |
| | (% by mass) | | | | | | | | | | |
| | (D) Caffeine (mg/100 g) | 34.7 | 34.7 | 34.7 | 34.7 | 34.7 | 17.4 | 34.7 | 34.7 | 130.2 | 46.3 |
| | pH (20° C.) | 5.57 | 5.57 | 5.57 | 5.57 | 5.57 | 5.57 | 5.57 | 5.67 | 5.67 | 5.64 |
| | Brix (20° C.) | 2.06 | 2.06 | 2.06 | 2.06 | 2.06 | 1.06 | 2.06 | 2.06 | 2.06 | 0.92 |
| Evaluation | Coarseness | 5 | 3 | 4 | 3 | 3 | 5 | 2 | 2 | 1 | 2 |
| | Sharpness of | 5 | 4 | 4 | 3 | 3 | 5 | 2 | 3 | 1 | 2 |
| | bitterness | | | | | | | | | | |
| | Retronasal aroma | 5 | 4 | 4 | 3 | 4 | 4 | 2 | 2 | 2 | 2 |

It found from Table 1 that a coffee beverage having suppressed coarseness and having good sharpness of bitterness and good retronasal aroma can be obtained by controlling the ratio of the total peak area of at least one selected from the group consisting of catechol and pyrogallol as the components (A) to the peak area of 3,4-dicaffeoyl-1,5-quinolactone as the component (B), ((A)/(B)), analyzed by LC-TOF/MS, to a specific range.

1-14. (canceled)

15. A coffee beverage, comprising components (A), (B), and (C):
(A) at least one selected from the group consisting of catechol and pyrogallol;
(B) 3,4-dicaffeoyl-1,5-quinolactone; and
(C) a chlorogenic acid,
wherein a ratio of a total peak area of the component (A) to a peak area of the component (B), ((A)/(B)), as determined by liquid chromatography-time of flight mass spectrometry (LC-TOF/MS) of the coffee beverage, is from 0 to 2.0,
wherein a content of the component (A) in the coffee beverage is from 1 to 10 ppm by mass,
wherein a content of the component (C) in the coffee beverage is from 0.05 to 2% by mass, and
wherein a Brix is from 0.8 to 3.0.

16. The coffee beverage according to claim 15, wherein the ratio of the total peak area of the component (A) to the peak area of the component (B), ((A)/(B)), as determined by LC-TOF/MS, is from 0.001 to 1.0.

17. The coffee beverage according to claim 15, wherein a content of catechol as the component (A) is 8 ppm by mass or less.

18. The coffee beverage according to claim 15, further comprising caffeine as a component (D), wherein a content of the component (D) in the coffee beverage is from 0.01 to 0.1% by mass.

19. The coffee beverage according to claim 15, wherein the coffee beverage has a pH of from 4.0 to 6.0.

20. The coffee beverage according to claim 16, wherein a content of catechol as the component (A) is 8 ppm by mass or less.

21. The coffee beverage according to claim 20, further comprising caffeine as a component (D), wherein a content of the component (D) in the coffee beverage is from 0.01 to 0.1% by mass.

22. The coffee beverage according to claim 21, wherein the coffee beverage has a pH of from 4.0 to 6.0.

23. The coffee beverage according to claim 22, which is a packaged coffee beverage.

24. The coffee beverage according to claim 23, which is a black coffee beverage.

25. The coffee beverage according to claim 23, which is a milk coffee beverage.

26. The coffee beverage according to claim 24, which is subjected to a heat sterilization.

27. A method of improving retronasal aroma of a coffee beverage comprising components (A) and (B):
(A) at least one selected from the group consisting of catechol and pyrogallol; and
(B) 3,4-dicaffeoyl-1,5-quinolactone,
the method comprising adjusting a ratio of a total peak area of the component (A) to a peak area of the component (B), ((A)/(B)), as determined by liquid chromatography-time of flight mass spectrometry (LC-TOF/MS) of the coffee beverage, to from 0 to 2.0.

28. The method according to claim 27, further comprising adjusting a total content of the at least one selected from the group consisting of catechol and pyrogallol as the component (A) in the coffee beverage to from 1 to 10 ppm by mass or less.

29. The method according to claim 27, further comprising adjusting a content of catechol as the component (A) in the coffee beverage to 8 ppm by mass or less.

30. The method according to claim 27, further comprising adjusting a content of a chlorogenic acid as a component (C) in the coffee beverage to from 0.05 to 2% by mass.
